(19) United States
(12) Patent Application Publication
(10) Pub. No.: US 2008/0289115 A1
(43) Pub. Date: Nov. 27, 2008

(54) Automotive/Household/Lock/Other Bottle Cap Opener Key

(76) Inventor: Max D. Price, San Luis Obispo, CA (US)

Correspondence Address: Max Price, 1033 F Southwood, Dr San Luis Obispo, CA, 93401, US

(21) Appl. No.: 11/684,010

(22) Filed: Mar. 9, 2007

(51) Int. Cl. B25F 1/00; B67B 7/44

(52) U.S. Cl. 7/151; 81/3.09

(57) ABSTRACT

The bottle cap key opener is a combination of a common key and a common bottle cap opener and combining them in one convenient multi-purpose tool that can be used to open locks and bottles.

Milled or stamped from any durable metal including but not limited to hardened stainless steel or brass alloys. A key blank that can have its shank cut to become a working key which doubles as a bottle cap opener. Cut or stamped into the key bow is a mouth capable of receiving and removing a bottle cap.

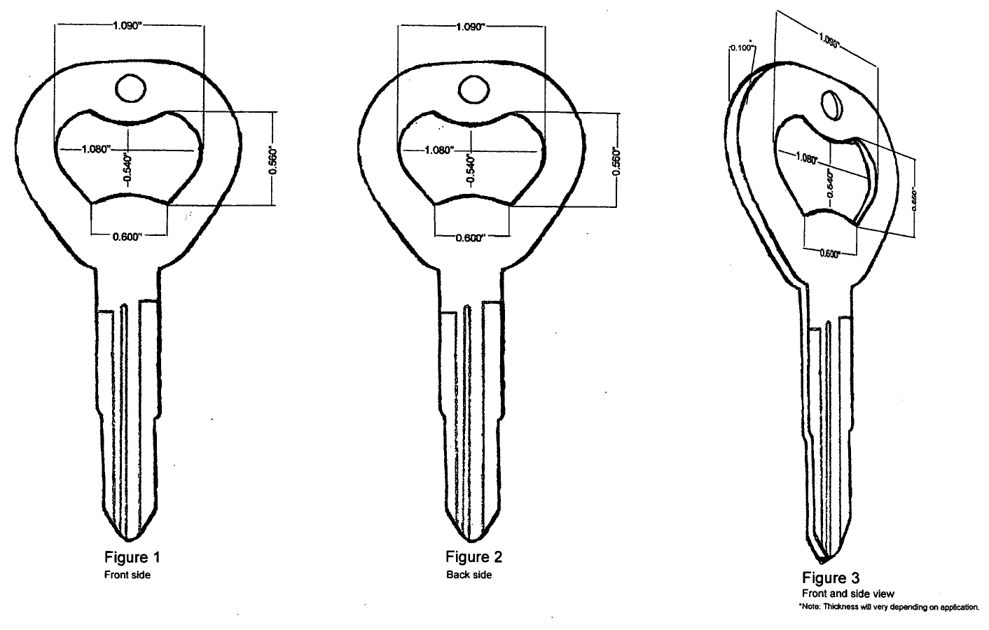

Working dimensions for the mouth are shown on all three figures and may be varied or adjusted according to functional limitations or artistic expression. The shank and bow dimensions are undefined and can vary according to the application of the key. Illustration is for an automotive key with known working dimensions for the mouth of the bottle cap opener. The front and back side are exactly the same as shown in FIG. 1 and 2 of the drawing. FIG. 3 gives one example of the many various thicknesses that may be used depending on the requirement for different locks that the opener may be machined to fit.

1. I Max D. Price a U.S. Citizen do claim to have invented the bottle cap key opener by taking a common key and a common bottle cap opener and combining them into one convenient multipurpose tool that can be used to open locks and bottles.
